(19) United States
(12) Patent Application Publication
(10) Pub. No.: US 2006/0277355 A1
(43) Pub. Date: Dec. 7, 2006

(54) Capacity-expanding memory device

(76) Inventors: Mark Ellsberry, Santa Clara, CA (US); Paul Sweere, Irvine, CA (US); Michael Sansur, Costa Mesa, CA (US); Grant Stockton, Fountain Valley, CA (US)

Correspondence Address: LOZA & LOZA, 6285 EAST SPRING STREET, # 327N, LONG BEACH, CA, 90808, US

(21) Appl. No.: 11/142,989

(22) Filed: Jun. 1, 2005

(51) Int. Cl. G06F 13/00; G06F 12/06

(52) U.S. Cl. 711/5; 711/154

(57) ABSTRACT

The invention relates to a device, system, and method for expanding the memory capacity of a memory module. A control unit and memory bank switch are mounted on a memory module to selectively control write and/or read operations to/from memory devices communicatively coupled to the memory bank switch. By selectively routing data to and from the memory devices, a plurality of memory devices may appear as a single memory device to the operating system. That is, the invention expands the addressable memory banks on a module by making two smaller-capacity memory devices emulate a single higher-capacity memory device.

### FIELD OF THE INVENTION

Various embodiments of the invention pertain to memory devices. At least one embodiment of the invention pertains to a controller and architecture that permits transparent bank switching of memory devices.

### DESCRIPTION OF RELATED ART

Memory devices have widespread use in electronic products. Many computing devices enable memory expansion by including one or more slots in which to couple a memory module. One type of commonly used memory module is the dual inline memory module (DIMM). Typically, memory modules include a small circuit board with contact pads along one edge to couple to a slot on another circuit board, such as a computer motherboard. In some cases, the contact pads are placed on two surfaces of the small circuit board along an edge of the small circuit board. In some implementations, the number and size of the contact pads may be defined by various bus or communication standards. In other implementations, the physical space available for such contact pads and/or electrical traces or buses may determine the number and size of the contact pads.

Memory devices are typically mounted on one or two surfaces of the small circuit board of the memory module. Dynamic random access memory (DRAM) chips are often used in memory module applications. The memory devices are communicatively coupled to the contact pads such that data may be sent to a memory module and stored in the memory devices. Various electrical paths are used to transfer data, specify a memory address, and control the flow of the data to and from the memory devices.

To access locations in memory devices, such as DRAM, a memory location is typically specified by the system over an address bus. This address is decoded to access the correct memory device. Some memory systems map memory addresses into a column and row. Row address and column address signals are time-multiplexed to permit a greater number of memory locations to be addressed without increasing the number of address lines.

As electronic devices become more sophisticated, the need for greater storage or memory increases. Since many electronic applications are restricted by industry standards and physical limitations prevent increasing a bus size (i.e., adding more contact pads and/or electrical paths to a memory module and/or system memory controller is often prohibitive) the maximum size of the addressable memory on a memory module may be limited. Thus, increasing the memory capacity of a memory module would require a larger bus size. This is often undesirable and impractical for backward compatibility of existing devices and established industry standards.

U.S. Pat. No. 6,526,473 describes a scheme to speed up the writing and reading cycles to memory devices. A control signal is used to connect only selected memory modules to a data bus at one time during a data transfer cycle in which data is input and output. By connecting only the addressed memory module(s) to the data bus, the load capacitance on the data bus is minimized. While this scheme provides ways to speed up writing to and reading from memory devices, it does not enable expanding the total memory capacity of a system beyond the limits of the data bus used.

U.S. Pat. No. 6,070,217 describes a scheme to maximize the memory capacity of a memory module while minimizing the capacitive loading of the data bus. Switches are placed between the bus interface and memory devices to activate or deactivate the line to the memory devices. When deactivated, the switches present high impedance thereby reducing the loading on the data bus. When a switch is activated, only the corresponding memory device is activated and adds a minimal capacitance to the data bus. While this patent presents a solution to bus loading, it does not enable expanding the total memory capacity of a system beyond the limits of the data bus used.

U.S. Pat. No. 6,414,868 describes a memory expansion module including an upper and a lower memory bank and a control unit that selects between the upper and lower memory banks based on an external bank select signal. That is, two memory banks are added to the memory module and the controller selects which memory bank to access based on an externally generated signal (i.e., high-order address bit). This scheme is undesirable as it is incompatible with modern memory devices (e.g., DDR and DDR2 SDRAM) and industry standards.

U.S. Patent Publication 2004/0000708 describes a stacked chip scale-packaged memory module that conserves board space while reducing bus impedance. A high-speed switching system, field effect transistor (FET) switches, is employed to select a data line associated with each level of a stacked memory module to reduce the loading effect on the data lines in memory access. The problem with this scheme is that while FET switches have a fast propagation delay, their switch time is too slow and imprecise to reliably comply with industry standards, such as the Joint Electron Device Engineering Council (JEDEC) standards, used in many memory applications.

### SUMMARY OF THE INVENTION

The invention relates to a device, system, and method for expanding the memory capacity of a memory module. A control unit and memory bank switch are mounted on a memory module or, alternately, on a system motherboard to selectively control write and read operations to/from memory devices communicatively coupled to the memory bank switch. By selectively activating or deactivating the memory devices in real-time, separate smaller-capacity memory devices may emulate a single larger-capacity memory device. That is, the invention expands the addressable memory capacity on a module by making two smaller-capacity memory devices emulate a single higher-capacity memory device. A state machine is used to send Read/Write commands to the intended memory bank while sending no-operation commands to the other memory bank. This permits maintaining multiple memory banks communicatively coupled to the data bus without device activation and termination cycle delays.

One embodiment of the invention provides a system having a processor, a bus communicatively coupled to the processor to carry data to and from the processor, and memory sockets coupled to the bus. A memory module is coupled to a memory socket, the memory module including a control unit to receive memory address information from the bus, and a memory bank switch communicatively coupled to the control unit and the bus. The control unit maps a received logical address to a physical address corresponding to the particular memory bank configuration employed. It also directs commands to the memory banks to indicate which memory bank should be operational and which one should be passive (do nothing). The memory bank switch is designed to receive data information from the bus and direct the data information to a plurality of physical memory banks according to control signals from the control unit that maps one logical memory bank to a plurality of physical memory banks. The memory module further includes a plurality of memory devices coupled to the plurality of physical memory banks, the plurality of memory devices appearing as a single memory device to the system processor. That is, the emulated single memory device has the capacity of the combined plurality of memory devices.

The invention expands the memory capacity of a memory module by using a plurality of smaller-capacity memory devices that function as a single higher-capacity memory device. This is accomplished without the need to add more lines to the bus or any additional external signal. Moreover, the load on the bus is not increased because the memory bank switches present a single load to the bus, not the load of the individual memory devices coupled thereto. A control unit provides a state machine that controls the commands to a plurality of memory devices in multiple banks so as to read/write a single memory bank without the need to disconnect the other memory banks from the data bus.

### BRIEF DESCRIPTION OF THE DRAWINGS

FIG. 1 illustrates a computing system that includes a capacity-expanding memory device according to one embodiment of the invention.

FIG. 2 illustrates a block diagram of a capacity-expanding memory device according to one embodiment of the invention.

FIG. 3 illustrates a block diagram of an address and command processing system for a capacity-expanding memory device according to one embodiment of the invention.

FIG. 4 illustrates a block diagram of a data processing system for a capacity-expanding memory device according to one embodiment of the invention.

FIGS. 5 and 6 illustrate memory modules according to two different embodiments of the invention.

FIGS. 7A-F illustrate an address mapping table, or bank switch state machine, that may be used by the control unit to map a received address (primary address space) to one of the memory banks (secondary address space) according to one embodiment of the invention.

FIGS. 8A-B illustrate a command scheme for a control unit to operate multiple banks concurrently according to one embodiment of the invention.

FIG. 9 illustrates a plurality of bits that are squelched from the original extended mode register set (EMRS) command according to one embodiment of the invention.

FIGS. 10, 11, 12 and 13 illustrate different configurations of memory modules (e.g., DIMMs) that can be built using combinations of the control unit and bank switch according to various embodiments of the invention.

### DETAILED DESCRIPTION

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

In the following description, certain terminology is used to describe certain features of one or more embodiments of the invention. The term “memory device” refers to any device capable of storing information, including DRAM. The term “memory module” refers to any package in which one or more memory devices are mounted (e.g., DIMM, SIMM, etc.).

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One embodiment of the invention relates to a system that expands the memory capacity of a memory module without increasing the bus size. A controller and memory bank switch allow the use of separate smaller-capacity memory devices to emulate a single higher-capacity memory device to a host system. This effectively expands the number of addressable banks per memory module without the need for additional chip select lines on the main memory bus. For example, the invention expands the addressable memory banks on a module by making two smaller-capacity memory devices emulate a single higher-capacity memory device. In one implementation, the invention permits two separate SDRAM DDR devices to appear as a single higher-capacity SDRAM DDR device to a source device (e.g., microprocessor, memory controller, etc.).

FIG. 1 illustrates a computing system 100 that includes a capacity-expanding memory device according to one embodiment of the invention. The computing system 100 may include a processing unit 102 coupled to an input/output (I/O) controller 104 to receive and/or send information. The processing unit 102 may also be coupled to a memory module 106 to retain or store information. The memory module 106 may include an embodiment of the capacity-expanding memory device 108 that permits increasing the memory capacity without increasing the bus size or communication path 110 to and/or from the memory module 106. In one implementation of the invention, the bus size or communication path 110 to and/or from the memory module 106 is not modified to accommodate the capacity-expanding memory device 108. Thus, the capacity-expanding memory device 108 is compatible with existing system architectures and transparent to the rest of the system (e.g., microprocessor, operating system, etc.). Moreover, the resistive and/or capacitive load on the bus 110 is not increased because the memory module 106 presents a single load to the bus 110, not the load of the individual memory devices coupled thereto.

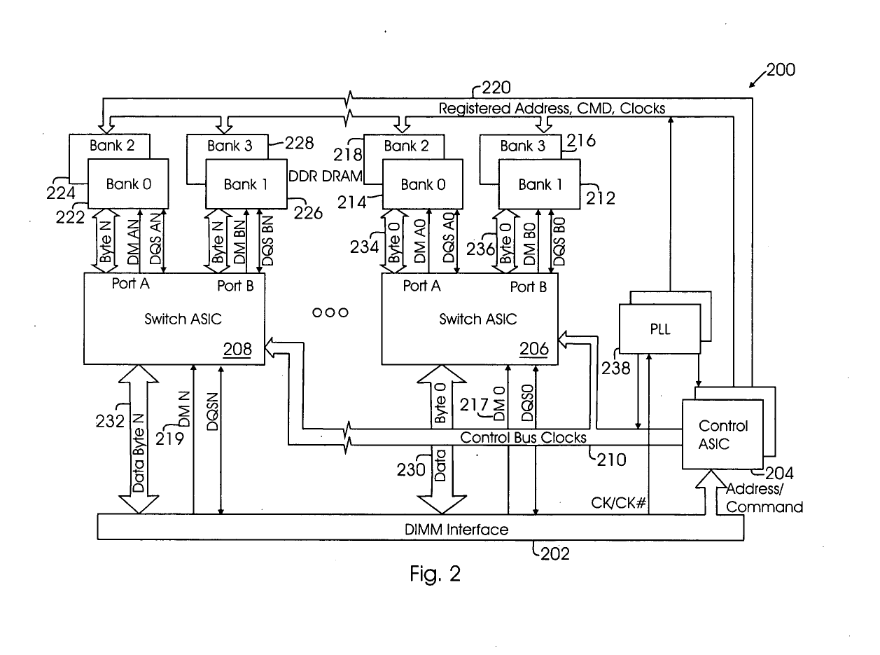

FIG. 2 illustrates a block diagram of a capacity-expanding memory system 200 according to one embodiment of the invention. In this embodiment of the invention, the capacity-expanding memory system 200 is communicatively coupled to a DIMM interface 202. The DIMM interface 202 may be coupled to a memory socket and communication bus over which data, memory addresses, commands, and control information are transmitted. The capacity-expanding feature of the invention is accomplished by a combination of a control unit 204 and one or more memory bank switches 206 & 208.

The control unit 204 receives memory addresses and commands over the DIMM interface 202. In one embodiment of the invention, memory bank switches 206 & 208 receive data information from the DIMM interface 202 via data buses 230 & 232, respectively. The control unit 204 is communicatively coupled to the dual memory bank switches 206 & 208 via a control bus 210 and indicates to the memory bank switches 206 & 208 how data from the DIMM interface 202 should be received and/or stored.

According to one embodiment of the invention, the DIMM interface 202 provides a range of data bits simultaneously (e.g., Data Group 0 through Data Group N). A first data group (i.e., Data Group 0) is received by a first memory bank switch 206 while a second data group (i.e., Data Group N) is received by a second memory bank switch 208. Each memory bank switch 206 & 208 is communicatively coupled to a plurality of memory banks that may have one or more memory devices (e.g., dynamic random access memory (DRAM)). Data may be read from or written to these memory devices using any known addressing scheme (e.g., mapping memory addresses into a column and row). For example, memory bank switch 206 includes Port A and Port B, coupled to data busses 234 & 236 respectively, through which it sends and receives data information to and/or from four memory banks (i.e., Bank 0, Bank 1, Bank 2, and Bank 3). The four memory banks (i.e., Bank 0, Bank 1, Bank 2, and Bank 3) 212, 214, 216, and 218 are also communicatively coupled to an address bus 220 through which they receive address and command information from the control unit 204. Clocking information (Ck/Ck#) is received from the DIMM interface 202. An external phase lock loop (PLL) 238 regenerates a clock signal that can be used by the components on the memory system 200. The switch 208 may contain an internal PLL which derives the clock provided to the memory devices from the output of the external PLL 238.

In one embodiment of the invention, the control unit 204 decodes a memory address received over the DIMM interface 202, determines to which memory bank the received address corresponds, and causes the memory bank switch 206 and 208 to activate the correct memory bank. For example, if the control unit 204 determines that a particular address is associated with, or mapped to, Bank 1 212 coupled to memory bank switch 206, then it causes Port B to be activated and Port A to be disabled so that the data is written to the correct memory bank 212. Additionally, each memory bank switch 206 and 208 includes signal drivers to drive data signals to and from the memory banks and to and from the DIMM interface 202. This reduces resistive and/or capacitive loading of the data bus coupled to the DIMM interface and the bus 110 while emulating a standard memory device interface.

The control unit 204 may map a received address in a number of ways without departing from the invention. For instance, the control unit 204 may simply associate the lower memory addresses with Port A and higher memory addresses with Port B. Although address information may be sent to all memory banks over address bus 220, the memory bank switch 206 and/or control unit 204 determine which memory devices or banks are accessed (for either Read and/or Write operations, or other operations). The control unit 204 may implement a state machine that controls memory bank switches 206 and 208 thereby controlling which memory banks/devices coupled to Ports A and B are accessed.

According to one embodiment of the invention, the operation of the switch 206/208 and control unit 204 will vary depending on the memory addressing scheme (e.g., column or row addressing) implemented. In column mode operation, to meet system timing requirements, write-data is sent to both ports A and B of the switch 206/208 and control unit 204 uses the data mask (DM) signal to select the target memory device. That is, the DM signal indicates to which target memory device (e.g., Bank 0 214, Bank 1 212, Bank 2 218, or Bank 3 216) the data is written. Note that the DM signal 217/219 at the switch 206/208 is controlled by the control unit 204. Memory read operations, in column mode, work in a similar way as memory write operations. Both memory devices (e.g., Bank 0 214 and Bank 1 212), coupled to ports A and B, are read and the data from the selected target memory device is multiplexed onto the DIMM interface 202. That is, only the data read from the selected target memory device is sent to the DIMM interface 202. Alternatively, when row/bank mode addressing is used, read and write commands are sent only to the targeted memory device. A NOP (no-operation) command is sent to the non-targeted memory device.

In one embodiment of the invention, a Serial Presence Detect (SPD) feature is implemented to collect and store the memory module configuration. The memory control configuration is communicated to the host system and stored. The memory module reports the total module memory capacity and data width along with the individual emulated memory device capacity that is formed by two or more small-capacity memory devices. The Serial Presence Detect operation is a standard feature of many DIMM modules.

In one embodiment of the invention, the control unit 204 is configurable via programmable pins (e.g., through logical pull-up or pull-down voltages, etc.) to have information about the type and size of memory devices coupled to the memory banks (e.g., Bank 0, Bank 1, Bank 2 and Bank 3). The control unit 204 is configured to recognize that a plurality of smaller-capacity memory devices is coupled to a particular memory bank switch. The control unit 204 then handles mapping the logical memory addresses it receives via the DIMM interface 202 to a corresponding bank for a particular memory bank coupled to the switches 206 and 208. This same principal is expanded when implementing a wider memory bus formed by several data groups composed of a plurality of memory bank switches and the associated memories.

The state machine implemented by the control unit 204 directs data to a particular memory bank based on the memory configuration of memory banks and the address received. For example, one or more of the address bits (e.g., in a column and/or row address bits) may be used to direct data to a particular memory bank.

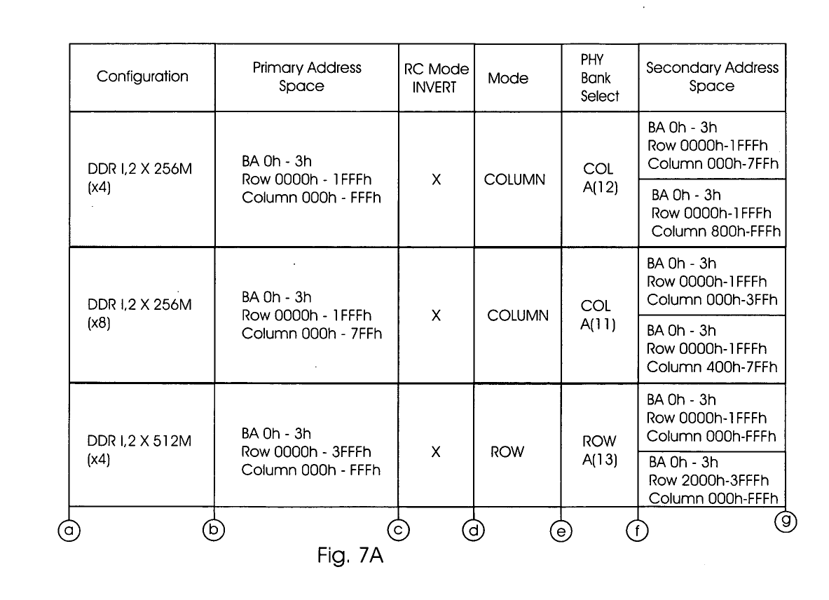

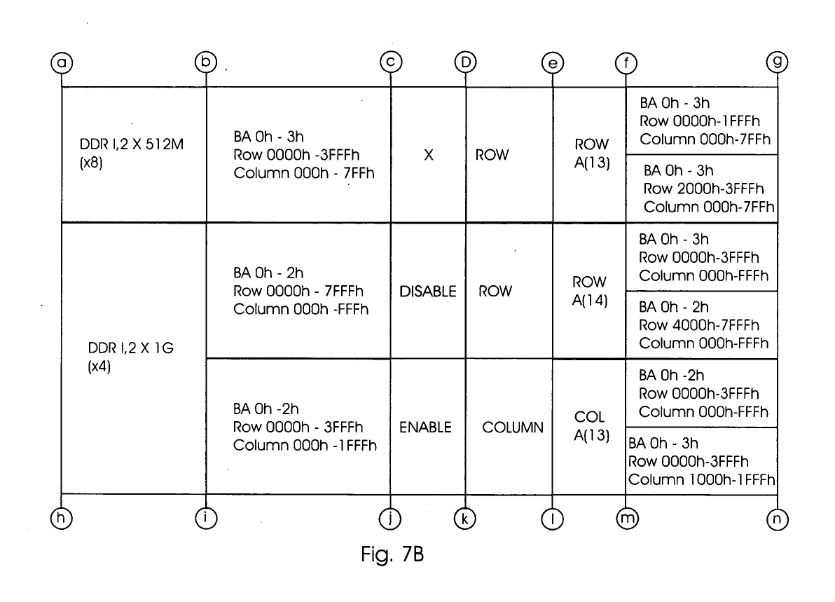

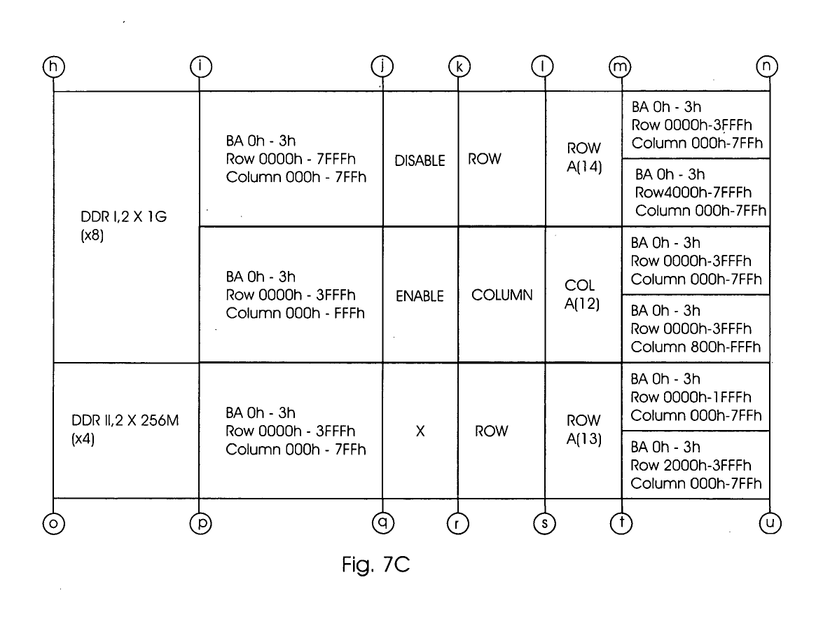

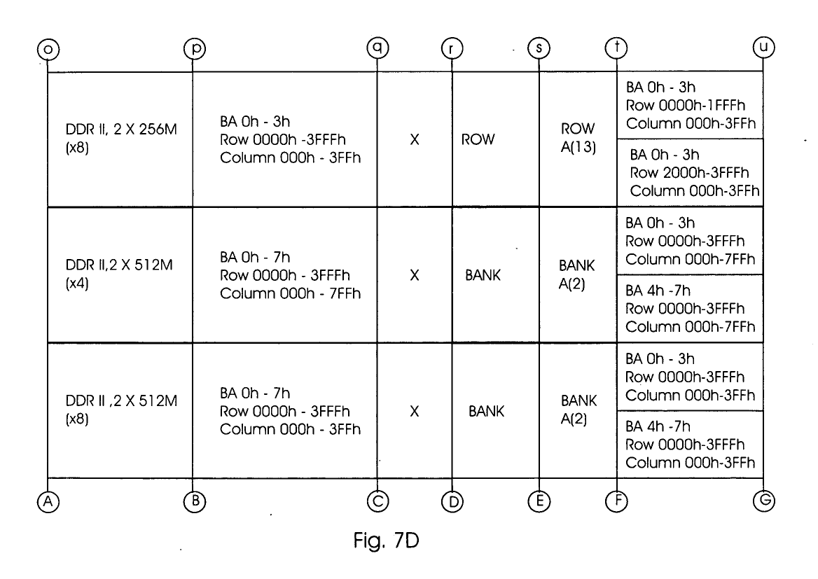

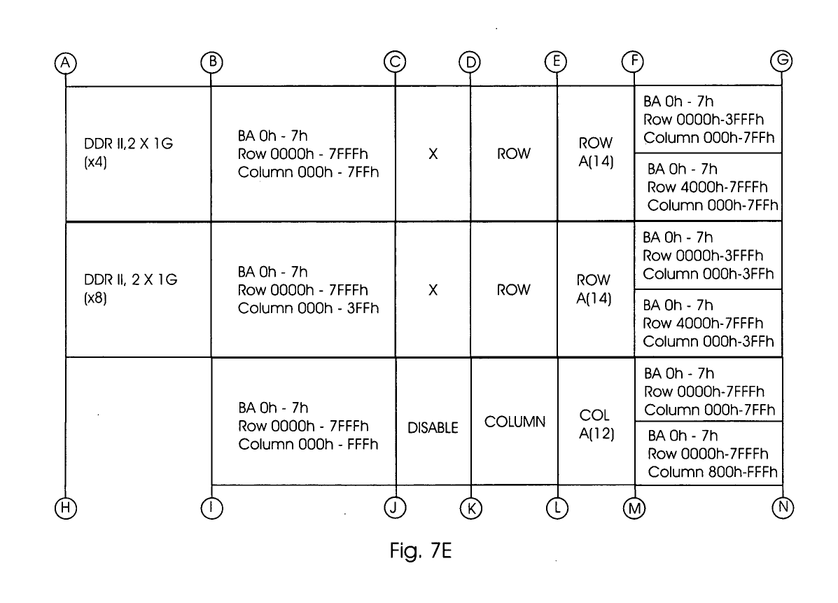

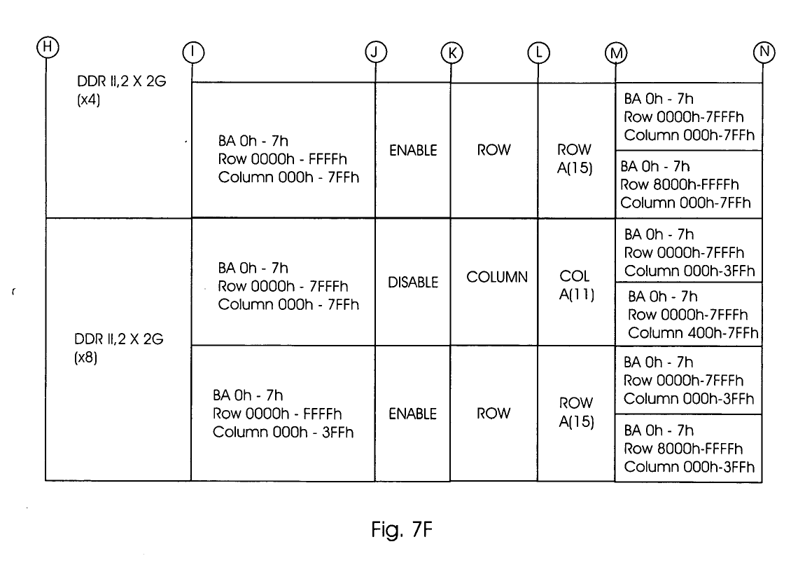

FIGS. 7A-F illustrate an address mapping table, or bank switch state machine, that may be used by the control unit to map a received address (primary address space) to one of the memory banks (secondary address space) according to one embodiment of the invention. In this particular example, addresses are represented as memory rows and columns. Depending on the physical memory configuration detected, the control unit 204 selects a particular address bit (e.g., the most significant address column or row bit) from the received address to map to the memory banks. For example, where a DDR 1, 2×256 Megabyte (×4) configuration is used in the memory banks, the address bit corresponding to Column 12 is used to select a memory bank (banks on Port A or Port B). Also, where a DDR II, 2×1 Gigabyte (×8) configuration is used in the memory banks, the address bit corresponding to Row 14 is used to select a memory bank (banks on Port A or Port B). Thus, a primary space address received by the control unit 204 is mapped to a secondary space address corresponding to the memory banks.

According to one embodiment of the invention, an application specific integrated circuit (ASIC) contains both the memory bank switch 206 and control unit 204 functions on a single die. This die is configurable to operate as either the memory bank switch 206 or the control unit 204 through a selection pin or pad.

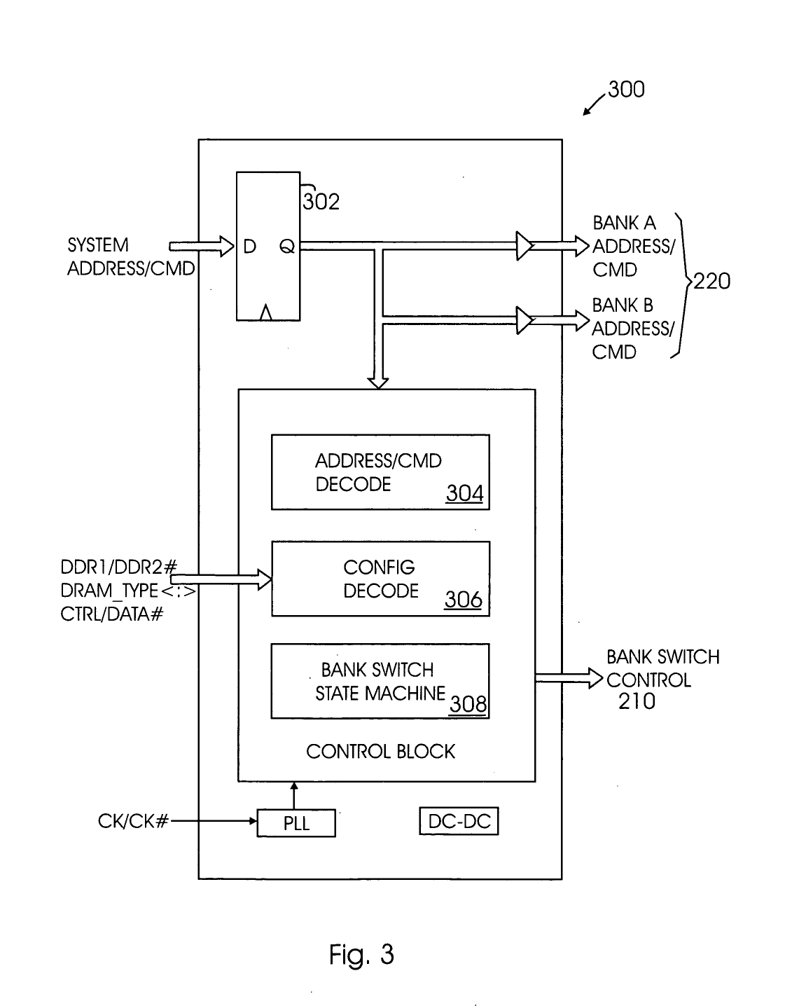

FIG. 3 illustrates a block diagram of an address and command processing system 300 for a capacity-expanding memory device according to one embodiment of the invention. This address and command processing system 300 may be implemented as part of the control unit 204. The command processing system 300 controls physical bank selection and bank switching direction. Memory addresses and command information are received from the DIMM interface 202, buffered in a register 302 and sent to all memory banks (e.g., Bank 0, Bank 1, Bank 2 and Bank 3) over address bus 220. The memory address and command information is also decoded 304 and memory configuration information 306 (e.g., DRAM type, etc.) is determined. The memory configuration information may be determined from preset information. A bank switch state machine 308 then determines which memory bank should be activated or accessed. In one embodiment of the invention, this state machine 308 is a logical translation table that maps a primary space address to a secondary space address based on the memory configuration present. For example, the state machine 308 may be the address mapping table illustrated in FIGS. 7A-F, which was previously described. The state machine 308 sends control information to the memory bank switches 206 & 208 via the control bus 210 to indicate which memory banks should be activated/deactivated or accessed.

In one embodiment of the invention, the control unit 204 maps one logical memory bank to two physical memory banks. This is accomplished by selectively enabling or activating one of the two physical memory banks (e.g., either Port A or Port B) while disabling or deactivating the other. In this manner, only one of the two physical memory banks is written to or read from. This scheme permits the operating system to generate memory addresses for a single, larger-capacity memory device while the control unit 200 maps that memory address to a plurality of smaller-capacity memory devices. Thus, the control unit 204 is able to map one logical memory bank to a plurality of physical memory banks.

One embodiment of the invention provides a novel scheme for performing operations in a first memory bank (i.e., Port A in FIG. 2) without disabling or deactivating a second memory bank (i.e., Port B in FIG. 2). This scheme permits the memory bank switch 206 to operate in real-time and without noticeable delays. For example, in one implementation of the invention, the control unit 204 (FIG. 2) operates to send commands or instructions to two or more memory banks (e.g., Ports A & B) concurrently. That is, the control unit 204 sends the intended instruction to the selected memory bank and sends a no-op (no operation) instruction to the other memory bank(s).

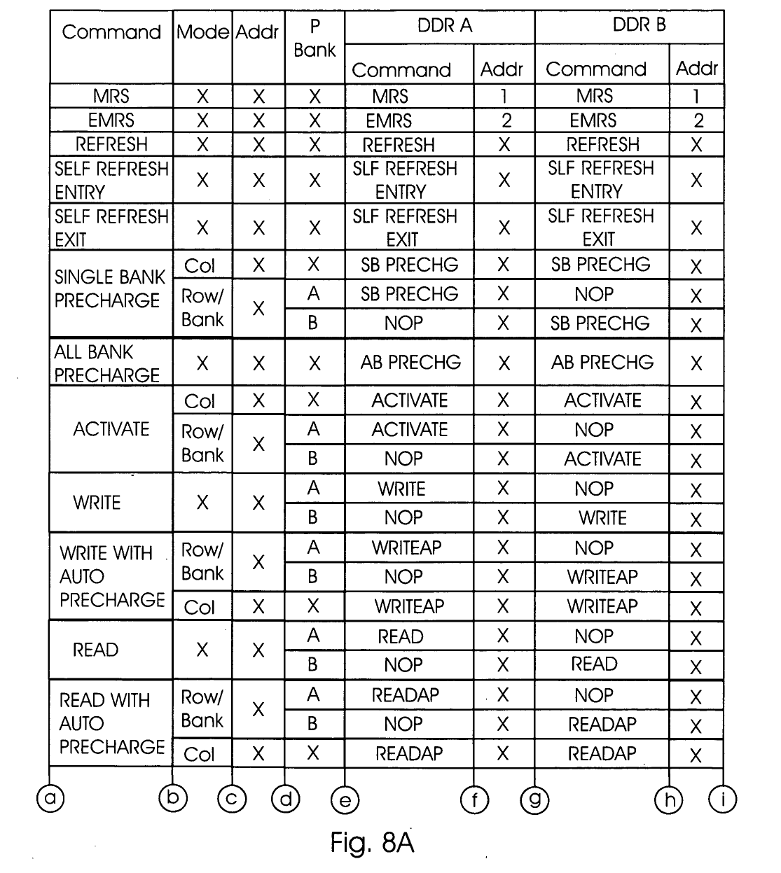

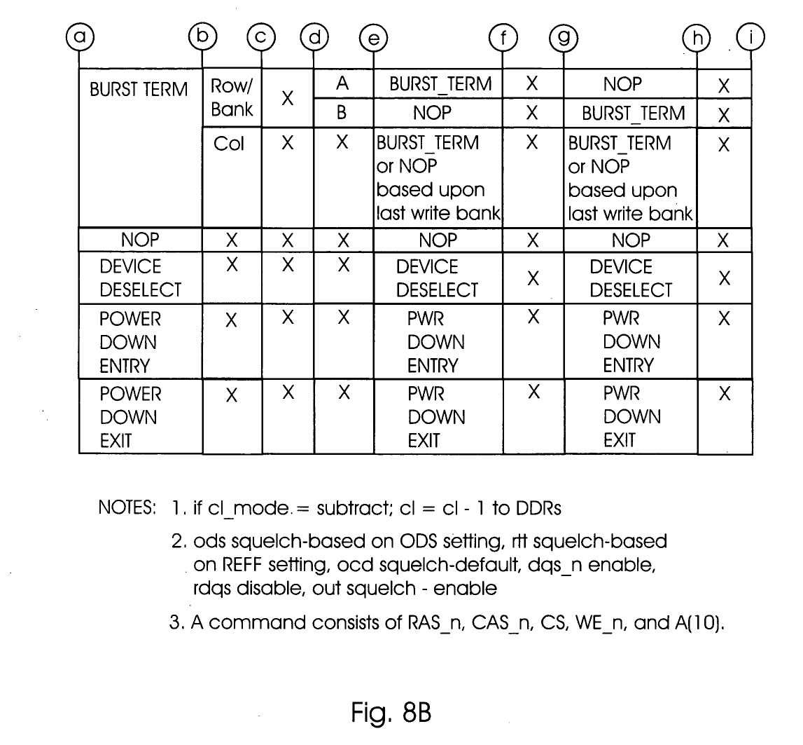

FIGS. 8A-B illustrate a command scheme for the switch/control unit combination to operate multiple banks concurrently according to one embodiment of the invention. In this implementation, two memory banks (i.e., DDR A and DDR B) are controlled by a control unit 204. An exemplary set of memory commands and/or operations are illustrated. Depending on which command is invoked and the memory addressing scheme used (e.g., column or row addressing), the control unit 204 operates to send either the same command to both memory banks (DDR A and DDR B) or different commands to each memory bank. For example, a “WRITE” command from the control unit 204 causes a “WRITE” operation to be sent to the intended memory bank (as determined by the address mapping) and a NOP command (no operation) to be sent to the other memory bank. Thus, data is written to a memory bank (e.g., banks on DDR A) while the other memory bank (banks on DDR B) receive a NOP. A “READ WITH AUTO PRECHARGE” (READAP) command would cause different actions depending on the addressing mode or memory configuration. If Row/Bank addressing is used, then a READAP command is sent to the intended bank while a NOP command is sent to the other bank. If Column addressing is employed, then the same READAP command is sent to both DDR A and DDR B. In Column addressing, the data mask (DM) signal (FIG. 2) may be used to select the target memory device (i.e., banks on DDR A or DDR B) to which data is written. Similarly, other instructions are implemented where either (1) the commands are sent to both memory banks/devices and a DM signal is used to select the targeted memory device or (2) the command is sent to the targeted device while a NOP command is sent to the non-targeted memory device. Thus, the control unit and switch architecture can control data to and from the memory banks without the delays caused by otherwise disabling the banks.

Note that RC MODE INVERT in FIGS. 7A-F refers to a feature that may be used for expansion to larger target DDR SDRAMs. The RC MODE INVERT input swaps between column and row mode to select the value of the addressing to configure the controller and memory switch, accommodating variations in future memory device organization.

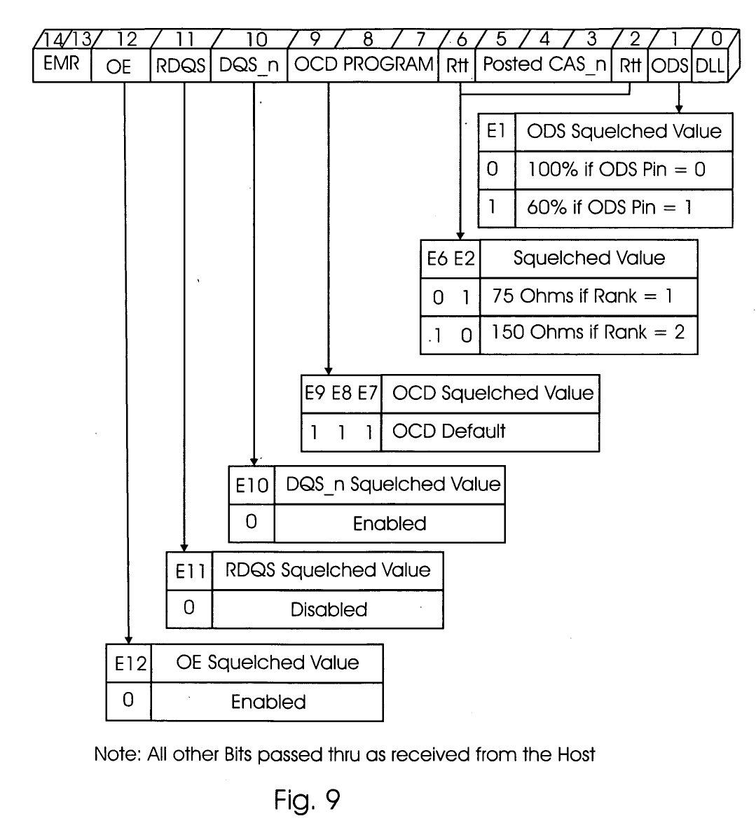

Another feature of the invention squelches or suppresses extended mode register set (EMRS) commands from being passed to the SDRAMs. Instead of passing these commands directly to the memory devices, the control unit passes the command to the memory bank switch where the values are stored and one or more of the EMRS commands are squelched, modified, or suppressed. FIG. 9 illustrates a plurality of bits that are squelched from the original EMRS command according to one embodiment of the invention. The squelch function allows the memory devices to be configured to operate in conjunction with the controller/switch devices and host system, rather than be directly programmed by the host system.

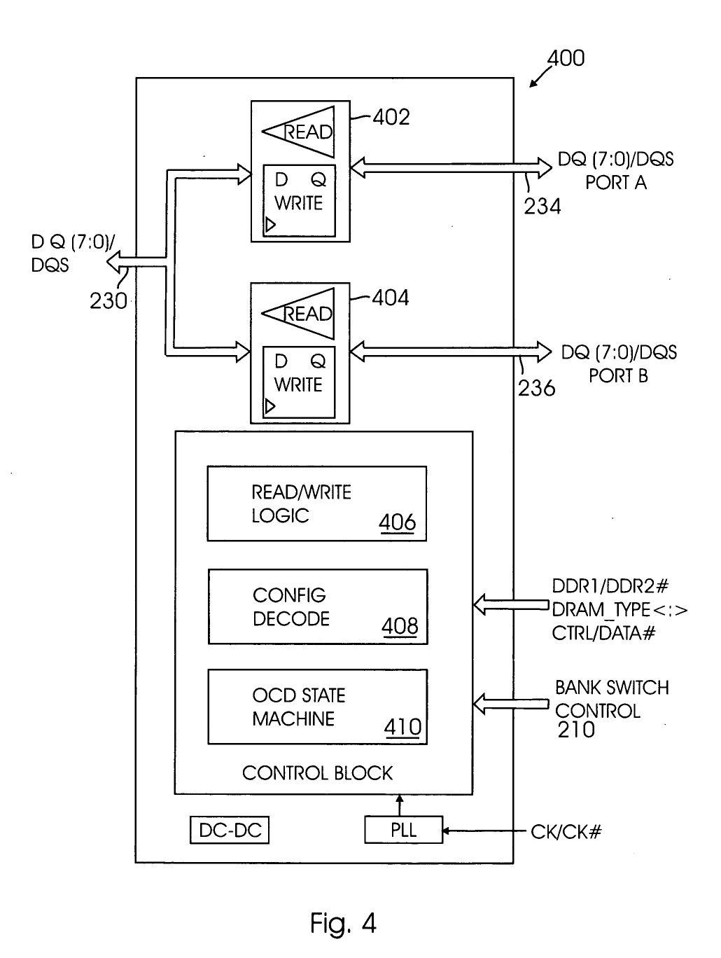

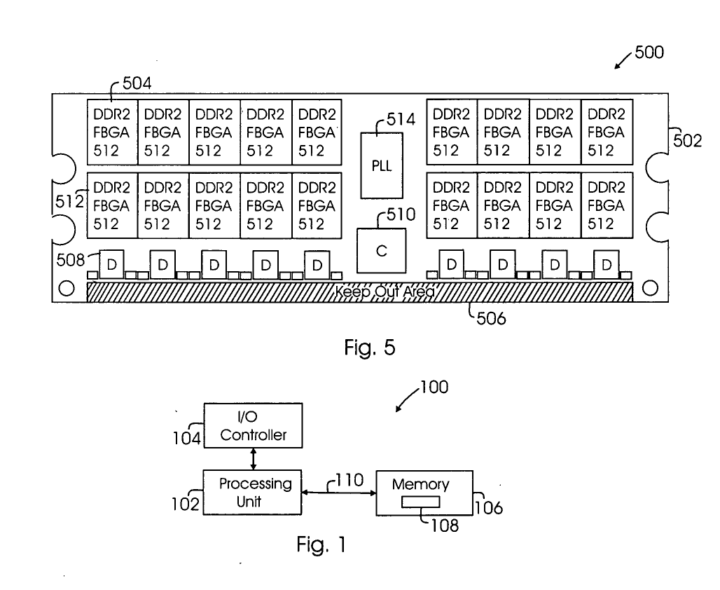

FIG. 4 illustrates a block diagram of a data processing system 400 for a capacity-expanding memory device according to one embodiment of the invention. This data processing system 400 may be implemented as part of the memory bank switch 206. Data is transmitted from the DIMM interface 202 via the data bus 230 to bidirectional signal drivers 402 & 404 that transmit and receive data over separate data busses 234 and 236 to the different sets of memory banks. A read/write logic unit 406 determines whether data is being read from or written to the memory devices (e.g., 212). Memory configuration information 408 is obtained from the control unit. An off-chip driver (OCD) state machine 410 is used by the system for impedance calibration using this tuning mechanism to adjust buffer drive strength to the DIMM interface 202. Typically, this impedance calibration takes place in the memory devices themselves, but in the present invention the OCD function is shifted to the switch device that sits between the memory devices and the DIMM interface.

According to one embodiment of the invention, the control system 300 and memory bank switch system 400 may be implemented on the same semiconductor die. The semiconductor die may be configurable (via a selectable line/pin, for example) to operate as either a control unit 204 or a memory bank switch 206. The control unit 204 and/or memory bank switch 206 may be implemented as an application specific integrated circuit (ASIC). In one embodiment of the invention, the control unit and bank switch combination allows the use of a system with two separate SDRAM DDR devices to emulate a single, two-times capacity, SDRAM DDR device. In various embodiments of the invention, the control unit and bank switch combination may support SDRAM DDR1 and DDR2 specifications (incorporated herein by reference) with memory capacities of 256 Mb, 512 Mb, and 1 Gb in speed grades of 200/266/333/400 Mbps in DDR1 and capacities of 256 Mb, 512 Mb, 1 Gb, and 2 Gb in speed grades of 400/533 Mbps in DDR2.

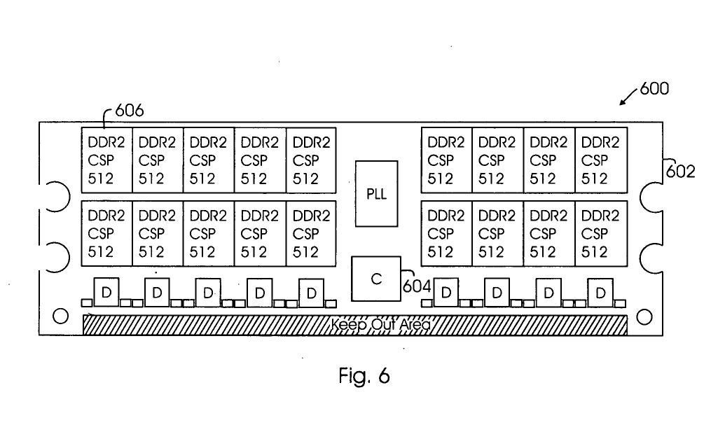

FIGS. 5 and 6 illustrate memory modules according to two different embodiments of the invention. In FIG. 5, the memory module 500 includes a substrate 502 on which a plurality of memory devices 504 are mounted. The memory module 500 also includes an edge interface 506 that serves to communicatively couple the memory module 500 to a memory slot or to a communication bus (e.g., memory bus, etc.). A memory controller 510 is mounted on the substrate 502 and configured to control write and read operations to/from the memory devices 506. The memory controller 510 is communicatively coupled to the edge interface 506 and receives address, command, and control signals from the edge interface 506. The memory controller 510 is also communicatively coupled to one or more memory bank switch 508 to control data Read and/or Write operations to/from the one or more memory devices 504 & 512. Memory bank switch 508 is communicatively coupled to memory devices 504 & 512 to route data to and from one or more of the memory devices 504 & 512. The memory bank switch 508 is also communicatively coupled to the edge interface 506 to pass signals between the edge interface 506 and the memory devices 504 & 512.

The operation of the memory controller 510 and memory bank switch 508, as previously described, causes the memory devices 504 & 512 to emulate a single memory device having the total capacity of the combined memory devices 504 & 512. That is, the operating system addresses a single logical memory bank which is mapped by the controller 510 to the physical banks of memory devices 504 & 512. An external phase lock loop (PLL) 514 receives a clock signal from the edge interface 506 and provides a clock signal to the memory module components.

According to one embodiment of the invention, a memory controller 510 is a control unit 204 and the memory bank switches 508 are memory bank switches 206 as described above. In various embodiments of the invention, the memory bank switches 508 may be electrically coupled to two or more memory devices 504 & 512, thereby expanding the capacity of a memory module 500.

In one implementation of the invention, illustrated in FIG. 5, the memory devices 504 & 512 on the memory module 500 may be arranged as nine memory bank switches or sets 508 having two memory banks 504 & 512 each. Each memory device has five hundred and twelve (512) megabits (MBit) of DRAM. As a result of this arrangement, the memory module 500 uses 512 MBit DRAM devices but appears, to the system processor, as a 1 GBit DRAM device. As a result of this architecture, the memory module presents a single electrical load to the system and is compatible with existing standards (e.g., JEDEC compatible, etc.). The Joint Electron Device Engineering Council (JEDEC) standards, used in many memory applications, are incorporated herein by reference.

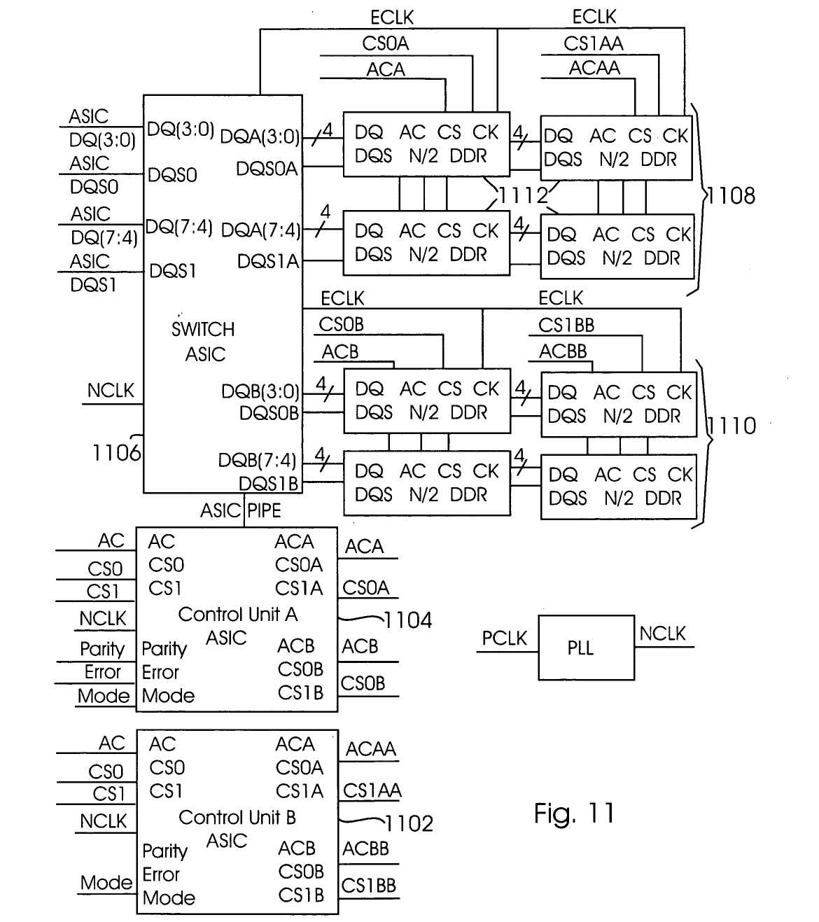

FIG. 6 illustrates another embodiment of the invention in which four banks of five hundred and twelve (512) megabits (MBit) memory devices 606, in a dual stacked configuration, are used. This memory module 600 uses a dual stack configuration (similar to that illustrated in FIG. 11) in which two control units 604 are employed, one control unit 604 on each side of the module 600. As a result of this arrangement, the memory module 600 uses 512 MBit DRAM devices which appear to the system processor as 2 GBit DRAM devices.

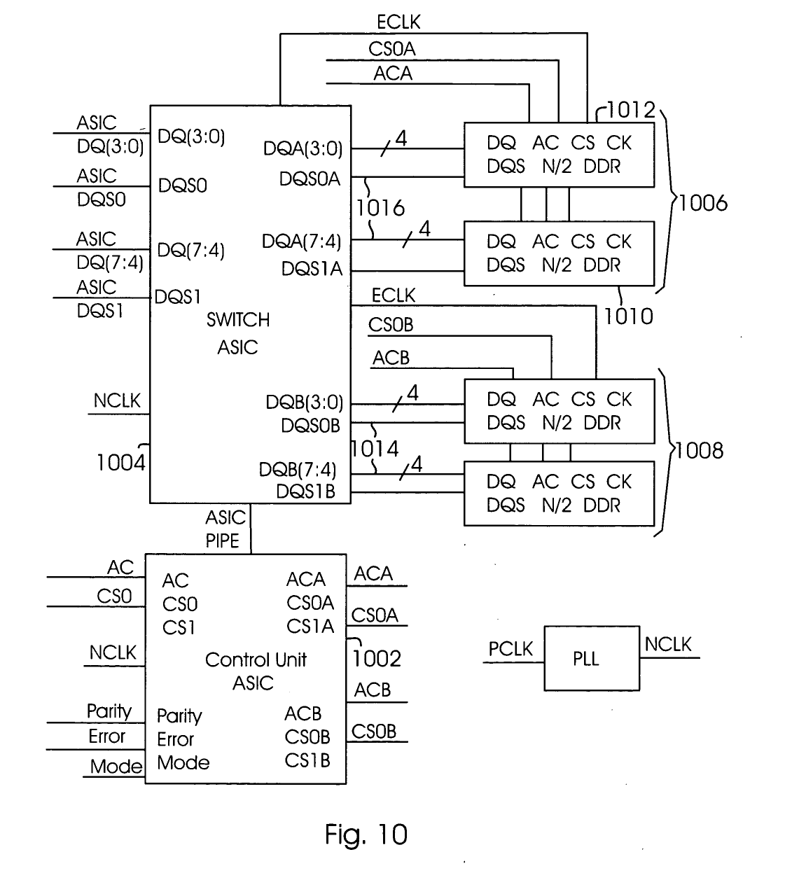

FIGS. 10, 11, 12 and 13 illustrate different configurations of memory modules (e.g., DIMMs) that can be built using combinations of the control unit and bank switch according to various embodiments of the invention. These configurations employ the control unit and bank switch previously described.

FIG. 10 illustrates a single chip-select memory configuration in which one control unit 1002 and one bank switch 1004 are used to control two memory banks 1006 & 1008, each memory bank having two memory devices 1010 & 1012 in separate data buses 1014 & 1016.

FIG. 11 illustrates a dual chip-select memory configuration in which two control units 1102 & 1104 and one bank switch 1106 are used to control two memory banks 1108 & 1110, each memory bank having four memory devices 1112.

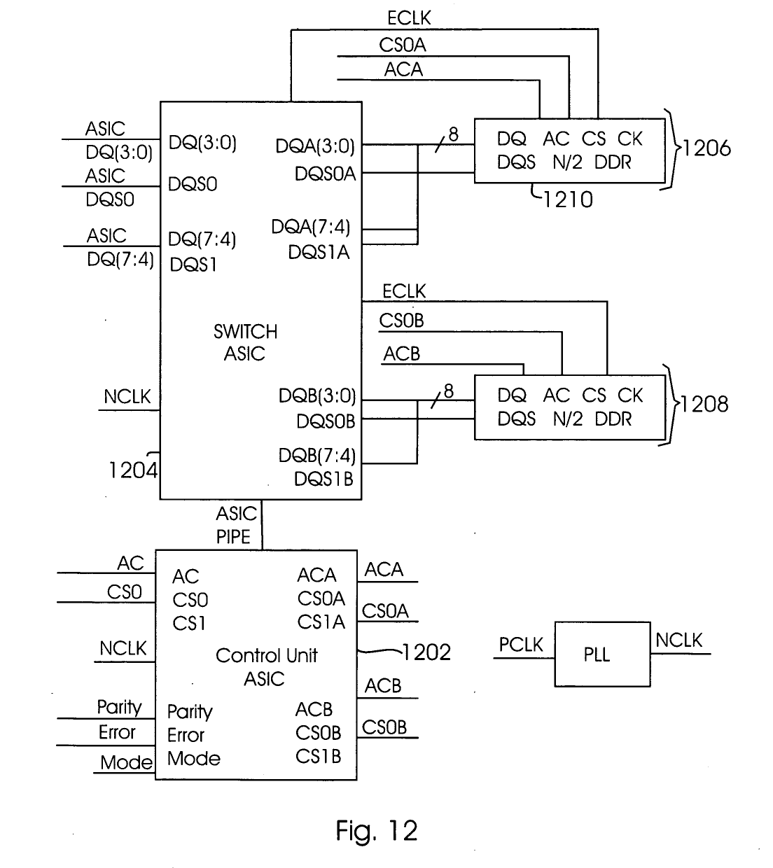

FIG. 12 illustrates a single chip-select memory configuration in which one control unit 1202 and one bank switch 1204 are used to control two memory banks 1206 & 1208, each memory bank having one memory device 1210.

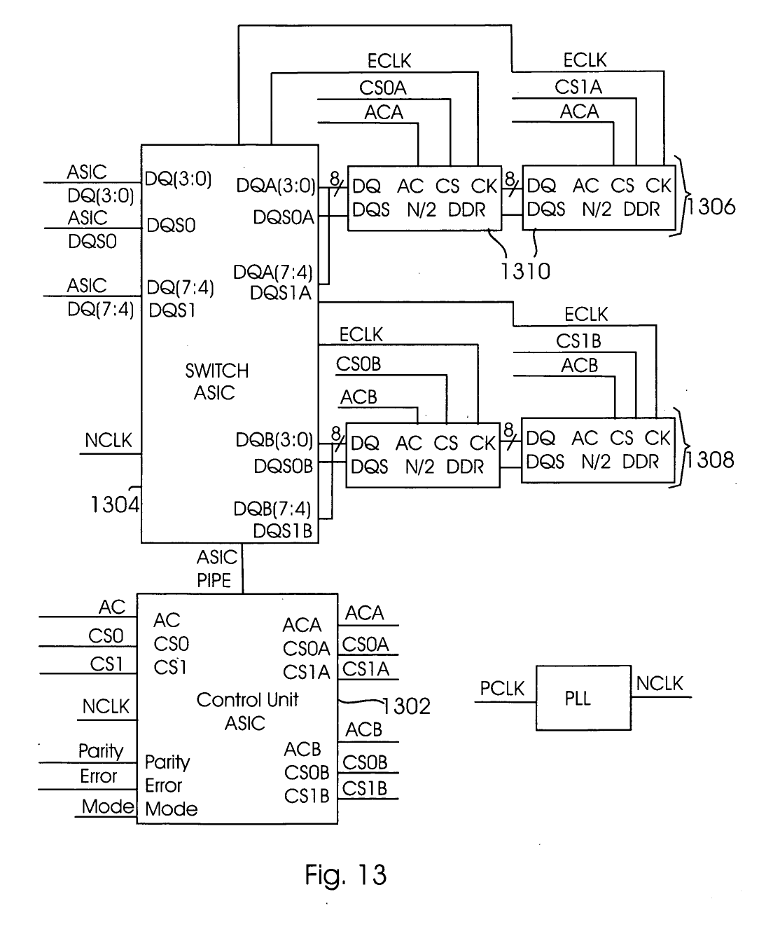

FIG. 13 illustrates a dual chip-select memory configuration in which one control unit 1302 and one bank switch 1304 are used to control two memory banks 1306 & 1308, each memory bank having two memory devices 1310 in one common bus.

Note that the fast switching between memory banks the switch and control architecture of the present invention permit memory access and distributed selection between memory devices at speeds not achievable in the prior art that complies with the standards for DDRI and DDRII. Field Effect Transistor (FET) based switches are too slow for the required high-speed switching as their switching speed is too imprecise. For example, the present invention can be implemented in DDRII systems operating at 533 MHz or higher.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

1. A system comprising:
a control unit to receive memory address and command information, the control unit to map a received memory address to a physical address corresponding one of a plurality of physical memory banks; and
a memory bank switch communicatively coupled to the control unit, the memory bank switch to receive data information and direct the data information to one of a plurality of physical memory banks in real-time according to control signals from the control unit.

2. The system of claim 1 further comprising:
a plurality of memory devices coupled to the plurality of physical memory banks, the plurality of memory devices appearing as a single memory device to external sources, wherein the memory bank switch includes signal drivers to present a single load to a bus coupled to the memory bank switch.

3. The system of claim 1 further comprising:
a first memory device coupled to a first port of the memory bank switch; and
a second memory device coupled to a second port of the memory bank switch,
wherein the control unit sends a read or write command to the first memory device while sending a no-operation command to the second memory device to cause the memory bank switch to read data from or write data to the first memory device.

4. The system of claim 1 wherein the control unit is configured to identify extended mode register set (EMRS) commands and suppress them from being passed to the plurality of physical memory banks.

5. The system of claim 1 wherein the control unit and memory bank switch are both included in a single application specific integrated circuit that can be configured to operate as either the control unit or the memory bank switch.

6. A memory module comprising:
a substrate;
a controller mounted on the substrate, the controller configured to receive memory address information and control data flow to one or more memory bank switches; and
a memory bank switch mounted on the substrate, the memory bank switch to transfer data information to and from two or more physical memory banks in real-time according to control signals from the controller that map one logical memory bank to the two or more physical memory banks.

7. The memory module of claim 6 further comprising:
a plurality of memory devices communicatively coupled to the two or more physical memory banks, the plurality of memory devices appearing as a single memory device to external data sources, the memory bank switch including signal drivers to present a single capacitive load to a bus coupled to the memory bank switch.

8. The memory module of claim 6 further comprising:
a first memory device coupled to a first port of the memory bank switch; and
a second memory device coupled to a second port of the memory bank switch, the two memory devices appearing as a single memory device having the combined total capacity of the first and second memory devices,
wherein the control unit sends a read or write command to the first memory device while sending a no-operation command to the second memory device to cause the memory bank switch to read data from or write data to the first memory device.

9. The memory module of claim 6 further comprising:
an edge interface along an edge of the substrate, the edge interface communicatively coupled to the controller to provide address information to the controller, the edge interface also communicatively coupled to the memory bank switch to provide data information to the memory bank switch.

10. The memory module of claim 6 wherein the memory module is a dual inline memory module compliant with a Joint Electron Device Engineering Council (JEDEC) standard.

11. A device comprising:
a memory control circuit to receive address information and map one logical memory bank to a plurality of physical memory banks; and
a memory bank switch circuit to receive data information and direct the data information to one of the plurality of physical memory banks,
the device being configurable to operate either as a memory control circuit or a memory bank switch circuit.

12. The device of claim 11 wherein the plurality of physical memory banks appears as a single memory bank to external data sources, the control unit is configured to receive a read or write command and send the read or write command to the first memory device while sending a no-operation command to the second memory device to cause the memory bank switch to read data from or write data to the first memory device.

13. The device of claim 12 wherein the single memory bank has the apparent capacity of the combined memory devices coupled to the plurality of physical memory banks.

14. The device of claim 11 wherein the memory bank switch circuit also retrieves data information stored in plurality of physical memory banks and transmits it to a bus.

15. A system comprising:
a processor;
a bus communicatively coupled to the processor to carry data to and from the processor;
a memory socket coupled to the bus; and
a memory module coupled to the memory socket, the memory module including
a control unit to receive memory address information from the bus, and
a memory bank switch communicatively coupled to the control unit and the bus, the memory bank switch to receive data information from the bus and direct the data information to one of a plurality of physical memory banks according to control signals from the control unit that map one logical memory bank to a plurality of physical memory banks.

16. The system of claim 15 wherein the memory module further includes
a plurality of memory devices coupled to the plurality of physical memory banks, the plurality of memory devices appearing as a single memory device to the processor.

17. The system of claim 16 wherein the single memory device has the capacity of the combined plurality of memory devices.

18. The system of claim 15 wherein the memory module further includes
an edge interface along an edge of the memory module, the edge interface communicatively coupled to the control unit to provide address information to the control unit, the edge interface also communicatively coupled to the memory bank switch to provide data information to the memory bank switch.

19. The system of claim 15 wherein the memory module is a dual inline memory module compliant with a Joint Electron Device Engineering Council (JEDEC) dynamic random access memory (DRAM) standard.

20. The system of claim 15 wherein the memory bank switch also retrieves data information stored in plurality of physical memory banks and transmits it to the bus.

21. A method of manufacturing a memory module, comprising:
forming an edge interface along the edge of a substrate;
placing a control unit on the substrate, the control unit communicatively coupled to the edge interface to receive memory address information; and
placing a memory bank switch on the substrate, the memory bank switch communicatively coupled to the control unit and the edge interface, the memory bank switch to receive data information from the edge interface and direct the data information to one of a plurality of physical memory banks according to control signals from the control unit that map one logical memory bank to a plurality of physical memory banks.

22. The method of claim 21 further comprising:
placing a plurality of memory devices on the substrate, the memory devices communicatively coupled to the plurality of physical memory banks, the plurality of memory devices appearing as a single memory device.
